(19) United States
(12) Patent Application Publication
(10) Pub. No.: US 2021/0158662 A1
(43) Pub. Date: May 27, 2021

(54) Light Emitting User Interface for Diving Computers

(71) Applicant: Riccardo Brama, Carovigno (IT)

(72) Inventor: Riccardo Brama, Carovigno (IT)

(73) Assignee: Dive Industries s.r.l., Follonica (IT)

(21) Appl. No.: 17/070,976

(22) Filed: Oct. 15, 2020

Related U.S. Application Data
(60) Provisional application No. 62/940,319, filed on Nov. 26, 2019.

(51) Int. Cl. G08B 5/36; G06F 3/02; G06F 3/01

(52) U.S. Cl. CPC G08B 5/36; G06F 3/017; G06F 3/02

(57) ABSTRACT

A Diving Computer Light Emitting User interface providing a way to inform the user and nearby people about information either calculated or sensed by the Diving Computer itself. The light emitting user interface is equipped with at least one luminous source and a proper way to modulate its light emission. The information conveyed by the light emitting user interface is encoded by means of luminous animations that can be activated or deactivated as per user needs. The light emitting user interface is also capable of increasing the visibility of the diver both during surface swimming and during diving. Moreover the light emitting user interface can be properly activated in order to enlighten purposedly the user surroundings so to provide an emergency source of light. The information provided by means of the luminous sources is able to catch both diver and surrounding divers attention thus increasing the safety of the diver.

### CROSS-REFERENCE TO RELATED PATENT APPLICATIONS

This patent application claims the benefit of U.S. Provisional Patent Application No. 62/940,319, filed Nov. 26, 2019, and entitled “Light Emitting User Interface for Diving Computers”. The entire teachings and disclosure of hereabove cited Provisional Patent Application are incorporated herein by reference thereto.

### FIELD OF THE INVENTION

This invention relates to an user interface conceived in such a way that light can be used in order to promptly provide informative content and enhanced features. More particularly, to a way to integrate light sources, such as colored light emitting diodes (LEDs), within the body of a Diving Computer and various ways to employ those light sources transforming them in information and features providing devices.

### BACKGROUND OF THE INVENTION

Self-Contained Units for Breathing Air (SCUBA) diving equipment, and the improvement of related technologies, opened up the underwater world also to non professional divers, posing the foundations to recreational and technical dives. Nevertheless since the very first experiences of hyperbaric environment permanence, it become evident that exposure to ambient pressures greater than surface pressure do pose important intrinsic risks for health and safety. It is for this reason many training agencies operating in the diving market suggest certified divers not to perform solo-dives and to follow redundancy based risk management strategies. Diving with a buddy dramatically decreases the risk associated with diving activities providing both redundant life-supporting devices (tanks, regulators and so on) and active help in case of accidents.

An important improvement in the diving risk management has been represented by the introduction of Diving Computers. Such devices allow to calculate, basing on mathematical models of the diver body (usually addressed to as decompression algorithms), inert gases dynamics within diver body so to obtain decompression limits, i.e. the maximum time a diver can stay at the current depth prior to incur in mandatory decompression stops, and to suggest the most appropriate ascent and decompression profiles, should any decompression stop be required. Diving Computers can also be used in order to monitor diver behaviors (such as ascent or descent speed), to inspect diver breathing gas consumption, to monitor diver gas reserves, to avoid exposition to toxic quantities of oxygen and more. In other words to provide information to the user, otherwise stated the diver, allowing him to properly respect safety protocols and to surface safely after a prolonged exposition to an hyperbaric environment.

Nonetheless, Diving Computers can also be used, in conjunction with proper user interface devices, in order to enhance the efficiency of buddy support: if the buddy could be informed in real-time about the status of the Diving Computer worn by another diver, his help could become proactive instead of passive, where with passive it is meant only after the other diver lets him know he needs help. That need still has to be addressed and it is one of the main targets of the present invention.

### DESCRIPTION OF THE PRIOR ART

It is well known for those skilled in the art that gathering user attention by means of an electronic device is not an easy task. It is even harder and more critical when diver attention has to be triggered: this both because the diver is usually focused on the activity performed (be it taking pictures, looking at underwater wildlife, or executing a task) and because the effect of nitrogen—inert component of the breathable air—is, at depth, narcotizing. At the same time it is not difficult to understand that, due to the particular severity of damages that could arise to diver health, it is of utmost importance to stimulate diver reactions as soon as a dangerous situation is either detected or calculated. In order to do so the preferred solutions present in the prior art usually comprise: the use of easily readable displays, the use of acoustic or vibrational actuators, the use of light sources usually fitted in easily spottable positions.

As an example, U.S. Pat. No. 6,856,578B2 (reissued as RE42,218E) discloses an underwater alert system in which visual, audible and tactile alert devices are equipped. In that case the visual alert could be a light source (such as a Light Emitting Diode—LED), the audible alert could be an electroacoustic transducer, also called beeper or buzzer, and the tactile alert is preferably implemented by means of a small motor equipped with an asymmetrically attached mass. U.S. Pat. No. 7,612,686B1 discloses an emergency underwater notification device which also addresses the need to attract divers attention by means of both a light source and an acoustic transducer.

U.S. Pat. No. 8,081,422BE discloses a breathing gas supply visual broadcast apparatus that employs at least one light source as a mean to inform the diver and surrounding buddies about the level of gas contained by his tank.

U.S. Pat. No. 4,283,798 discloses an attitude indicator for divers in which, again, it is made use of a series of LEDs to allow a diver to determine his relationship to the true horizon.

Pat. 2014/0226270A1 discloses a modular Diving Computer in which a huge and high resolution display is used as primary source of information for the diver.

U.S. Pat. No. 6,592,235B1 discloses a light emitting glove allowing a diver both to be facilitated on a task completion and to be more easily seen from a distance in low visibility waters. Of course this is not the only prior art trying to provide a solution to increase the visibility of a diver: U.S. Pat. No. 6,745,762B1 discloses a snorkel with a luminous device fitted on top of it.

An important innovation in the art has been represented by the introduction of the so called head-up displays. Those devices are especially, but not exclusively, used in conjunction with rebreather units (space exploration derived devices allowing a diver to recirculate breath so to minimize the loss of inert gases in the surrounding environment thus allowing for more compact breathing units design) and are usually either fitted with one or more light sources that, blinking, warn user of dangerous situations, or with a display and a way to focus it on diver field of view.

Pat. WO2010076177A1 discloses a display unit for a diving mask in which a display, together with a proper lens, is used to produce a viewing window displaying Diving Computer information.

User interfaces employing light emitting devices have also been disclosed by previous art in different market segments such as the one disclosed by Pat. 2004/0179133 in which an illuminator based user interface allows the user to gather information about particular functions a camera is set to perform or about its operating mode.

None of the aforementioned inventions, by the way, addresses the need for informing a diver and at least one of his buddies about information available in his Diving Computer by means of luminous sources.

### SUMMARY OF THE INVENTION

The herein disclosed invention allows a Diving Computer, by means of light diffused by it, to provide a fast, easy and intuitive way for interfacing with the user or the nearby people.

Since same light sources may be used by the disclosed invention to carry different information with different criticality levels, a way to encode that information is integral part of the invention itself. Light sources may usually emit light both with different wavelengths (interpreted by the human eye as different colors) and with different brightness levels. Many light sources are also fast enough to allow their use intermittently with different switching patterns. By exploiting these light sources characteristics, the disclosed invention allows to produce a very wide range of animations (meaning with that the combination of at least one color, at least one brightness level, at least one switching pattern, and at least one light source). By bounding each animation to a different meaning it is thus possible to encode different information, with different criticality levels, by means of light sources.

In order to determine the positions of light sources with respect to diver's eyes, the disclosed invention provides a way for the user to specify how the Diving Computer is worn by the diver. Usually at least two inputs are needed: the Diving Computer rotation and the wrist at which the Diving Computer is worn. An embodiment of this invention could make use of sensors, as an example accelerometers, in order to spot the rotation of the device. Another embodiment may use a rotating selector to easily provide the needed information. A further embodiment may use a graphical user interface, together with at least one input device, allowing the user to specify properly the rotation of the device as a setting.

By means of the disclosed invention a diver, possibly but not limitedly at least one of his buddies, and possibly but not limitedly at least one of the surrounding divers have a mean of receiving information from the Diving Computer worn by the diver allowing all of them to react promptly, efficiently and correctly to that information. As a non limitative example, the diver is allowed to receive easily understandable information about both the Diving Computer and other diving equipment, such as pressure transmitter equipped tanks, statuses. By means of the information received, the diver, his buddy, or a surrounding diver, thus, have the chance to identify a problem is arising or it has been solved. A non limitative example of a problem that may arise is a too fast ascent. In such a situation an embodiment of this invention would preferably flash, in the distinguishable safety critical color, at least one of its light sources directed towards the surrounding environment. Another embodiment of this invention could flash at least one of its light sources directed towards the diver. A further embodiment of this invention may flash both the diver facing and the surrounding environment facing light sources.

Of course the ascent speed is not the only parameter that should be monitored in order to assess diver safety. The amount of elaborated information and the number of monitored sources depend on the capabilities of the invention implementing embodiment and are not to be interpreted as limiting the invention itself. As a non exhaustive example, an embodiment of the invention could monitor the dive depth and the time spent while underwater (the so called runtime); another embodiment could monitor also the tank reserve; another embodiment could add diver fatigue, monitored by means of his heart pulses, and many other.

The herein disclosed invention allows also to transform the Diving Computer in such a way for it to be used as a position signaling device to let the diver show his position to other people both while swimming on the surface and when diving. In this case the invention will preferably flash at preferably the maximum intensity level and in a distinguishable signaling color (such as, but not limitedly, the white color) preferably only the light sources directed far from wearing diver field of view. In such a way the diver wearing the invention equipped Diving Computer will not be dazzled by the position signaling light sources while providing to the nearby divers an easy and efficient way to spot him, even in low visibility situations.

A further feature the herein disclosed invention enables is to replicate information coming from other sources making them available via its light sources. A non limitative example of this feature is represented by the tank pressure transmitters (also referred to as tank pods) information replication. By using preferably, but not limitedly, at least one of its light sources the invention is able to encode the tank pressure content. Without limiting the generality of the invention, three different levels of gas reserve (namely safe level, warning level and critical level) may be encoded by the invention making use of distinctive animations.

The herein disclosed invention also allows to use at least one of its light sources as a way to illuminate the diver vicinity. This feature is preferably obtained by turning in preferably solid on switching pattern, with the maximum allowed brightness, the light sources. Since the light sources may also be used in order to help cameras auto-focusing or to correct their color balance, the invention may allow the user to specify freely the color to be used by light sources to enlighten the surrounding environment.

Hereabove cited features enabled by the disclosed invention are to be meant as exemplificative and do not limit in any way the invention itself.

The herein disclosed invention can be equipped in Diving Computers both as stand alone system and in conjunction with any other user interface such as, but not limitedly, either none or at least one display, either none or at least one button, either none or at least one buzzer, either none or at least one speaker, either none or at least one vibrating device. An embodiment of this invention allows the diver to select functions and information to be shown by the disclosed invention by means of appropriate buttons. Another embodiment allows to select functions and information to be shown by the disclosed invention by means of appropriate gestures preferably, but not limitedly, performed on at least one button or using the body of the device as a user input method. A series of non exhaustive gesture examples is hereafter provided: a prolonged push, a repeated push, a combination of pushes of at least one button, a Diving Computer body rotation, an hit on one of the parts of the Diving Computer hosting the disclosed invention, a combination of hits coming from the same or from different parts of the hosting device and so on. A further embodiment allows to select only specific functions by means of appropriate buttons or gestures on Diving Computer equipped buttons. A further embodiment allows to select functions and information to be shown by means of specific screens shown on the Diving Computer display.

### BRIEF DESCRIPTION OF THE DRAWINGS

The disclosed invention can be better described by means of the drawings hereinafter detailed.

FIG. 1 shows an example of a Diving Computer embodying the here disclosed invention (101). The Light Emitting User Interface for Diving Computers is realized as described in the preferred embodiment of this invention as a luminous band running through the whole perimeter of the device.

FIG. 2 details the top side (201), the right side (202), the bottom side (203), and the left side (204) of the Light Emitting User Interface for Diving Computers. Each side may be comprised by one or more LEDs so that to both increase the luminous flux and to allow more information to be shown at the same time.

FIG. 3 details the elements comprising the preferred embodiment of this invention. (301) is the Light Emitting User Interface for Diving Computers, comprised by the Variable Current Generator (305) and by one or more Light Emitting Devices. FIG. 3 does not detail the mounting positions of such devices since it is detailed in FIG. 1. (301) is interfaced with (302), the Central Processing Unit that, by means of its algorithms, is able to instruct (301) on what to show to the user.

FIG. 4 details an example of settings screens the preferred embodiment of this invention uses in order to specify Diving Computer orientation. Screen (400) allows, by means of selecting item (401), to specify the display rotation or, more precisely, if buttons (304) appear on top or on bottom of the device. Screen (403) identifies, by means of selector (402), the arm on which the diver wears the Diving Computer.

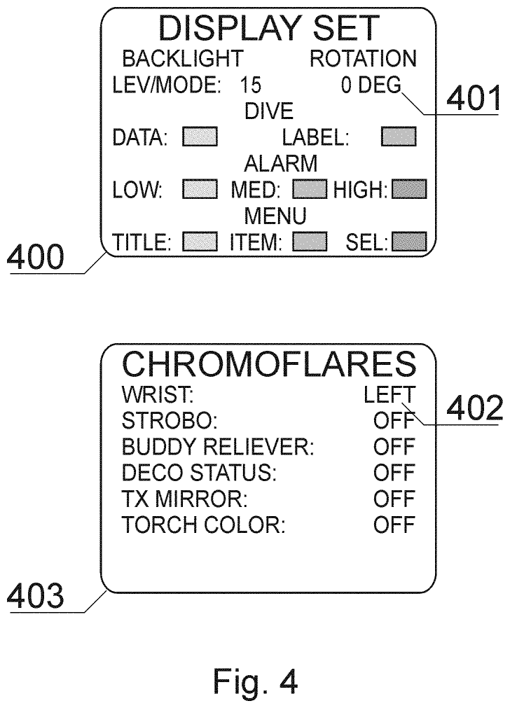

FIG. 5 shows the nominal mounting position of the preferred embodiment of this invention. (501) is the nominal top side, (502) the nominal right side.

### DETAILED DESCRIPTION OF THE PREFERRED EMBODIMENT

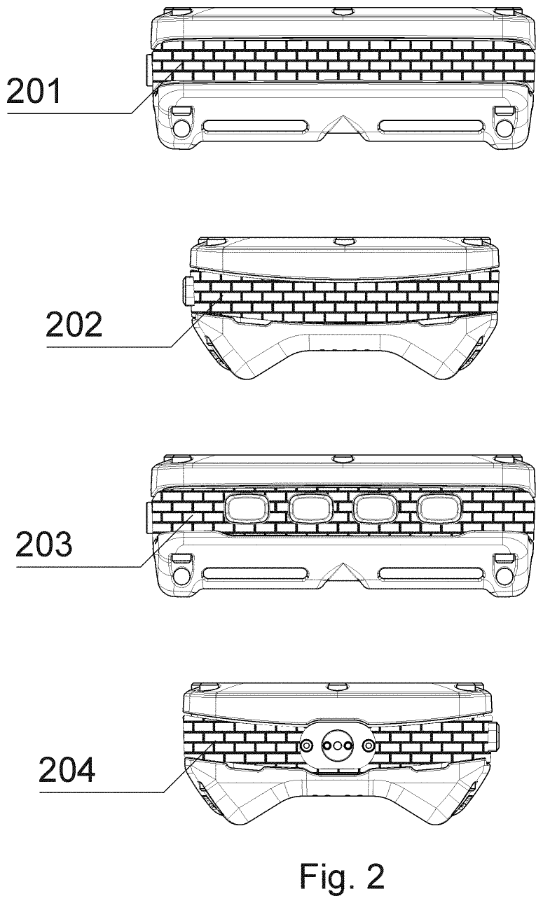

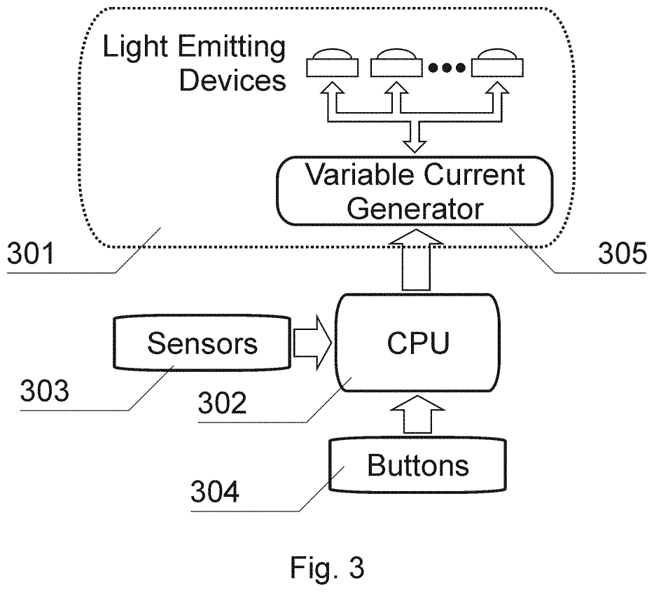

The preferred way to carry out this invention, marked as (301) in FIG. 3, is to make use of one or more colored light emitting devices (such as solid-state RGB Light Emitting Diodes—RGB-LEDs) per each side of the Diving Computer that equips it, as shown in FIG. 2. Those RGB-LEDs can be preferably controlled both in groups and independently by means of (305).

The Variable Current Generator (305) is a device allowing to provide LEDs with a current that can be varied both as intensity, on each of their red (R), green (G) and blue (B) channel, and as switching pattern. By appropriately defining the amount of current drawn per each R-G-B channel it is possible to both alter the emitted light luminous intensity and its color. It should be noted that (305) may be realized either as an independent peripheral or as an embedded peripheral within a more complex device that usually is indicated in the art as Micro-controller Unit (MCU), usually also comprising the Central Processing Unit (CPU).

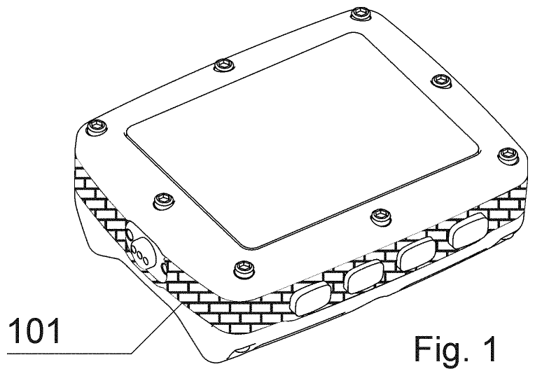

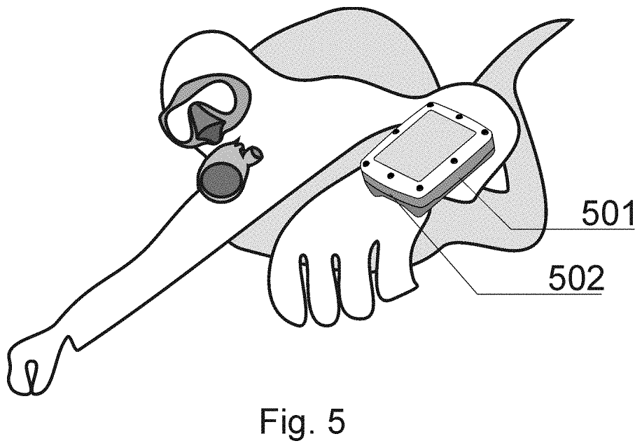

As shown in FIG. 1, the RGB-LEDs are mounted on the Diving Computer perimeter so that each body side can be made luminous. Preferably, and without limiting the generality of the description, a total of ten LEDs are equipped within the preferred embodiment: three of them are equipped on the top side (201), two of them on the right side (202), three of them on the bottom side (203) and again two of them on the left side (204). It should be noted that top (501), right (502), bottom and left sides are named after the nominal mounting position on diver's wrist that, without affecting the generality of this description, is supposed to be the, as shown in FIG. 5, the left arm with buttons facing the diver. The preferred embodiment of this invention requires the user to specify both rotation and wrist information on specific screens of the Diving Computer, shown respectively as (400) and (403). By altering the settings (401) and (402) it is possible to specify that the Diving Computer is mounted with buttons on top of the device: (401) set to “180 DEG” instead of “0 DEG”. At the same way by selecting “RIGHT” on selector (402) it is possible to indicate that the Diving Computer is mounted on the right arm instead that on the left one.

The preferred embodiment of this invention allows the diver to select which function and which information has to be shown by the invention preferably by means of (403): a Diving Computer appropriate screen that is usually accessed by means of a menu with the help of Diving Computer equipped buttons (304).

In the preferred embodiment of this invention the CPU (302) is able to elaborate data coming from one or more sensors (303) thus allowing instructing (301) to show animations that may depend on one of the following sources: information directly sensed by (303), elaborated information, elaborated information obtained by means of data coming from (303), information obtained from user interaction such as that enabled by means, as a non exhaustive example, of buttons (304).

The preferred embodiment of this invention allows to inform the diver and surrounding people about his safety state in up to five different levels of criticality. These levels are bound to the same number of preferred animations whose colors are encoded preferably, but not limitedly, as follows: red for safety critical information, yellow for warning information, blue for attention requests, white for important status information, green for confirmations of good status.

The preferred embodiment of this invention allows the user to specify, by means of screen (403), which light sources should be enabled to indicate the diver status and if a problem is identified. This allows the user to select if he is the only one needing to be warned, if only the buddy and surrounding divers should be informed, or if both the diver himself and the surrounding divers (together with the buddy) should be warned, thus obtaining the maximum level of safety. By flashing both diver facing and surrounding environment facing light sources, in fact, the invention provides, in a very easily understandable way, an indication that a problem is arising to all the possible actors for a solution. In case of a too rapid ascent, as described hereabove, the diver attention can be easily catched by the diver facing light sources, thus enabling a reaction from him that could be to deflate the buoyancy device (usually called jacket) he wears. At the same time since also the surrounding environment light sources are flashed, the nearby buddy is also enabled to react. The buddy could decide to swim promptly close to the diver experiencing the problem and provide him an increased negative buoyancy by hanging on him while deflating the jacket he is wearing.

A non exhaustive list of parameters the preferred embodiment of the disclosed invention monitors in order to assess diver safety comprises: the maximum dive time the user specified with a proper setting; the maximum depth the user specified with a proper setting; the maximum operating depth (also addressed to as MOD) due to the breathable mix the diver is inhaling; the decompressive plan and the depth at which the diver is diving compared with the mandatory decompression stops depth (if any is needed); the ascent speed; the gas reserve within the diver's equipped tanks (monitored by means of at least one sensor); the oxygen partial pressure to which the diver is exposed; the non-decompression time limit; the need for the diver to switch to a more appropriate breathable mix; the desaturation status of the diver; the no-fly limit; the suggestion to perform a non mandatory safety or a deep stop.

As described in the summary of this invention, the preferred embodiment allows the user also to be easily spotted while diving in low visibility environments. Also in this case it is by means of (403) screen that the diver can enable or disable freely, even while diving, whether the position signaling LEDs shall be activated or not. The preferred embodiment of this invention uses all the RGB-LEDs fitted within either the top (201) or the bottom (203) sides of the Diving Computer as position signaling light sources.

In order to perform tank transmitter information replication described in the summary hereabove, the preferred embodiment of this invention makes use of the RGB-LEDs mounted on the diver facing corners of the Diving Computer. Information criticality levels are encoded by the preferred embodiment by means of the following preferred animations: safe level is encoded with green blinks, warning level with yellow blinks and critical level with red blinks. The hereabove cited levels are used by the preferred embodiment of this invention when the tank content is: above two times the user specified reserve level, between two times and the user specified reserve level, or below the user specified reserve level respectively for safe, warning and critical level.

Since the preferred embodiment of this invention includes buttons (304) used as user interface, it is possible for the preferred embodiment of this invention to react on user needs, as an example by activating the illumination of diver vicinity (also known as torch function). The preferred embodiment implements both the turn-on and the turn-off of the torch preferably by means of a gesture on preferably the leftmost of (304) buttons. That gesture, a prolonged push on the button, is activated preferably only when the Diving Computer is showing dive related screens. Moreover the activation of the torch is subject to Diving Computer battery charge conditions. In case the battery level is too low: either the torch turn-on is refused or, in case it is activated, the torch is at first blinked and, on critically low battery levels, turned off. When the torch turn-on is refused the disclosed invention itself is used to inform the diver about this error by activating an animation on either the bottom (203) or the top (201) sides of the Diving Computer, depending—as usual—on Diving Computer mounting settings. The hereabove animation is preferably, but not limitedly, a blinking in red color of all the light sources equipped on the showing side. The preferred embodiment of this invention also allows to specify the torch color by an appropriate item of screen (403).

1. A Diving Computer Light Emitting Interface encoding information or providing additional features by means of animations on a multiplicity of light sources where:
Animation means a combination of at least one color, at least one brightness level, at least one switching pattern of at least one light source;
A switching pattern is a combination of a maximum of two logic states, namely on and off, with a ratio among on and off state time duration comprised between 0 and infinity and a repetition period comprised between 0 and infinity.

2. A Light Emitting Interface as claimed in 1 making use of at least one of its light sources to encode Diving Computer information;

3. A Light Emitting Interface as claimed in 1 where the information is computed by the Diving Computer itself with or without the information obtained from at least one sensor;

4. A Light Emitting Interface as claimed in 1 where the information is obtained from at least one sensor;

5. The Light Emitting Interface defined in claim 1 where the light sources are light emitting diodes;

6. The Light Emitting Interface defined in claim 1 where the light sources are light emitting diodes comprised by a multiplicity of channels emitting primary colors;

7. A Diving Computer Light Emitting Interface making use of at least one of its light sources to purposedly increase the visibility of a diver with a proper animation;

8. A Light Emitting Interface as claimed in 7 to enhance visibility of a diver swimming on surface;

9. A Diving Computer Light Emitting Interface making use of at least one of its light sources to purposedly enlighten the surrounding environment;

10. A Light Emitting Interface as claimed in 9 in which the light sources are enabled by means of a gesture on at least one of its user interface devices where:
Gesture is meant as a way to act on the user interface device with either a single or a repeated action in a more or less rapid sequence with a more or less prolonged action for each action of the sequence thereof;
User Interface device is meant as a device allowing a user to provide input to the claimed interface or an intermediary device thereof;
